(19) United States
(12) Patent Application Publication
(10) Pub. No.: US 2015/0220667 A1
(43) Pub. Date: Aug. 6, 2015

(54) APPLICATION-BASED VERIFICATION COVERAGE USING METAMODELS

(71) Applicant: Infineon Technologies AG, Neubiberg (DE)

(72) Inventors: Georg Pelz, Ebersberg (DE); Monica Rafaila, Munchen (DE)

(73) Assignee: Infineon Technologies AG, Neubiberg (DE)

(21) Appl. No.: 14/174,546

(22) Filed: Feb. 6, 2014

(51) Int. Cl. G06F 17/50; G06F 17/10

(52) U.S. Cl. CPC G06F 17/5009; G06F 17/10

(57) ABSTRACT

At least one processor of a computing device may create at least one metamodel. The at least one processor may further perform, on the at least one metamodel, one or more of: a split operation, a merge operation, a reduce operation, a mathematical transform, an inverse operation, a derive operation, a cascading operation, and an algebraic operation on the at least one metamodel.

### TECHNICAL FIELD

The disclosure relates to verification coverage using metamodels.

### BACKGROUND

A system may be validated to determine whether the system meets a set of requirements set forth in the system's target specification. For example, the system may be validated to determine whether system outputs are within the expected ranges set forth in the target specification given the range of conditions set forth in the target specification in which the system may be expected to operate. Validating the system may include performing sensitivity analysis to characterize the impact of existing sources of variation on the target behavior as well as worst-case analysis to determine the impact of extreme variations in conditions on the overall functionality of the system.

### SUMMARY

In one aspect, the disclosure is directed to a method. The method may include creating, by at least one processor of a computing device, at least one metamodel. The method may further include performing, by the at least one processor on the at least one metamodel, one or more of: a split operation, a merge operation, a reduce operation, a mathematical transform, an inverse operation, a derive operation, a cascading operation, and an algebraic operation.

In another aspect, the disclosure is directed to a computing system. The computing system may include at least one processor. The computing system may further include at least one module executing on the at least one processor and configured to: create at least one metamodel; and perform, on the at least one metamodel, one or more of: a split operation, a merge operation, a reduce operation, a mathematical transform, an inverse operation, a derive operation, a cascading operation, and an algebraic operation.

In another aspect, the disclosure is directed to a computer-readable storage medium comprising instructions. The instructions, when executed by at least one processor, cause the at least one processor to perform operations. The operations may include creating at least one metamodel. The operations may further include performing, on the at least one metamodel, one or more of: a split operation, a merge operation, a reduce operation, a mathematical transform, an inverse operation, a derive operation, a cascading operation, and an algebraic operation.

The details of one or more aspects of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1A is a block diagram illustrating verification coverage of a system using a metamodel.

FIGS. 1B and 1C are block diagrams illustrating responses versus factors of a metamodel.

FIG. 2A is a block diagram illustrating an example split operation performed on an example metamodel.

FIG. 2B is a block diagram illustrating another example split operation performed on an example metamodel.

FIG. 2C is a block diagram illustrating another example split operation performed on an example metamodel.

FIG. 2D is a block diagram illustrating an example merge operation performed on an example metamodel.

FIG. 2E is a block diagram illustrating another example merge operation performed on an example metamodel.

FIG. 2F is a block diagram illustrating a reduce operation performed on an example metamodel.

FIG. 2G is a block diagram illustrating another reduce operation performed on an example metamodel.

FIG. 2H is a block diagram illustrating a transform operation performed on example factors and/or example responses of an example metamodel.

FIG. 2I is a block diagram illustrating an inverse operation performed on example factors and/or example responses of an example metamodel.

FIG. 2J is a block diagram illustrating a derive operation performed on an example metamodel.

FIG. 3A is a block diagram illustrating how an example metamodel may be used to determine the most important factors for a system.

FIG. 3B is a block diagram illustrating responses versus factors of an example metamodel for an example op amp of a system.

FIG. 3C is a block diagram illustrating cascading an example metamodel with an example metamodel.

FIG. 3D is a block diagram illustrating replacing an example cluster of metamodels with a mathematically equivalent metamodel.

FIG. 3E is a block diagram illustrating performing mathematical operations on a metamodel.

FIG. 4 is a block diagram illustrating an example computing device.

FIG. 5 is a flowchart illustrating a process for performing operations on one or more metamodels.

### DETAILED DESCRIPTION

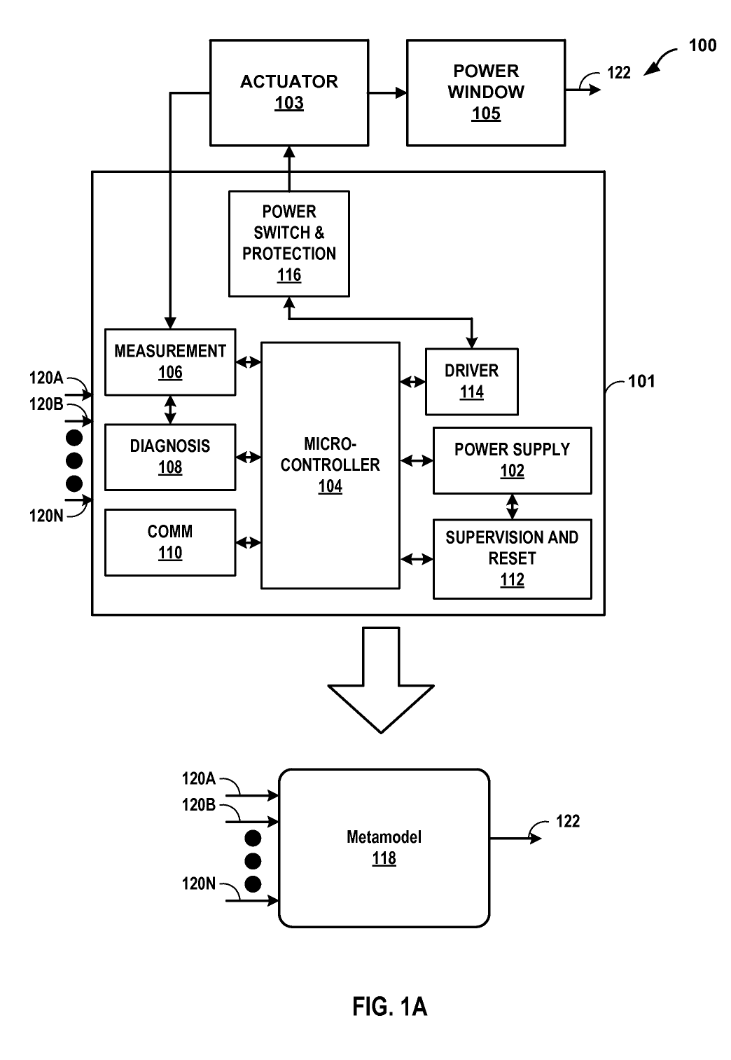

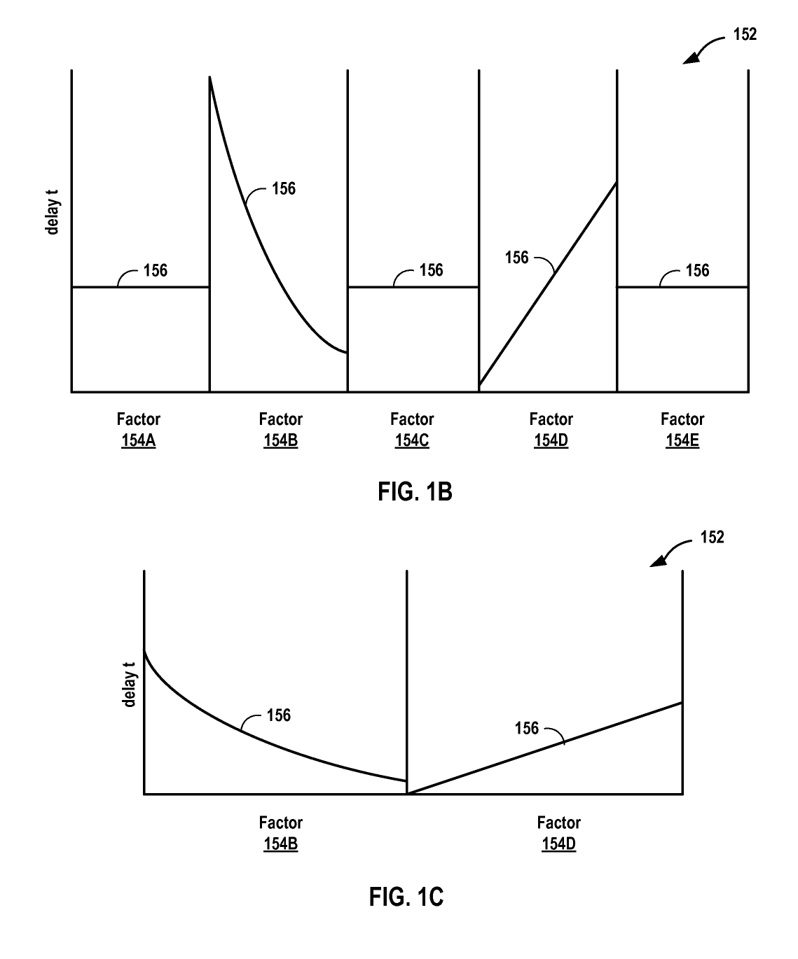

FIG. 1A is a block diagram illustrating verification coverage of a system using a metamodel. As shown in FIG. 1A, system 100 may be made up of interconnected components. For example, if system 100 includes an automotive electronic control unit (ECU) 101 for controlling power window 105 of a vehicle via actuator 103, ECU 101 may include components such as power supply unit 102, microcontroller 104, a measurement unit 106, a diagnosis unit 108, a communication unit 110, a supervision and reset unit 112, a driver unit 114, and a power switch and protection unit 116. ECU 101 may receive electrical signals indicative of sensor input and may process the signals to produce control signals directed towards actuator 103 for controlling the power window 105.

ECU 101 may perform a variety of tasks, such as interpreting commands received from a bus using communication unit 110, controlling power window 105, switching of power switches using power switch and protection unit 116, monitoring the speed and position of power window 105 using sensors, and checking for the presence of obstacles for power window 105 using measurement unit 106. ECU 101 may implement an anti-pinch effect for power window 105 so that when ECU 101 determines that an obstacle is blocking power window 105, ECU 101 may stop the movement of the power window 105, thereby preventing power window 105 from pressing (e.g., exerting a force) upon obstacles such as a person's finger.

To implement the anti-pinch effect, measurement unit 106 may measure the current through actuator 103, such as a direct current (DC) motor, driving power window 105. If measurement unit 106 measures an over-current condition, ECU 101 may determine that there is an obstacle blocking the normal rotation of the motor included in actuator 103. Measurement unit 106 may measure the current through the motor through a shunt resistance, and may also amplify the current via an operational amplifier included in measurement unit 106.

In implementing features of ECU 101 such as the anti-pinch effect, system 100 may be subject to factors 120A-120N, which may be sources of variation that may impact the operation of the anti-pinch effect that ECU 101 implements. These sources of variation may include, for example, process variations, tolerances of electrical components, calibration parameters of a regulation loop, fluctuations of transmission delay on the bus, the operating temperature, variations in supply voltage, variations in chip fabrication, variations in die (i.e., integrated circuit) positioning on a semiconductor wafer for components of ECU 101, and the like. The outputs of ECU 101, such as the control signals directed towards actuator 103 for controlling power window 105, may determine and/or derive response 122 of system 100, such as the force exerted by the power window against an obstacle, that may be affected by factors 120A-120N. A response, such as response 122, may be a measure of a component or system's performance or characteristic under verification. A response may not be variable in time and may take scalar values. For functional, safety, and/or quality reasons, validation of the behavior may mean that the response is within the required ranges. For example, the force exerted by power window 105 may be required to be within a specified range. The response may be measured from testing the physical system 100 or computed after a simulation of system 100. A factor may be a source of variation that has a potential impact on the response. A factor can be a controllable input of the simulation or measurement process. A factor may include variations that may occur during product fabrication or use of a component, such as tolerances of the components and/or the operation environment of the component. A factor may also include design parameters for system optimization. Each factor may have a specification of its ranges, probability distribution (discrete or continuous), and possible correlation to other factors.

To completely validate system 100, it may be necessary to test and/or simulate system 100 together with the surrounding components in system 100's operating environment under a variety of conditions to validate system 100's application fitness. For example, factors 120A-120N may be varied across a range of conditions and the response 122 measured and/or simulated to determine whether the control signals outputted by ECU 101 are within the expected ranges set forth in the specification. However, because system 100 may be a complex system, it may take a long time to set up and completely validate a physical embodiment of system 100. Furthermore, it may sometimes be impossible to test system 100 in certain operating conditions and states.

Because of limited resources, often only a limited number of data points may be extracted from simulation or measurement of system 100. However, for system verification to ensure the system fits the application it was designed for, the performance of a system may need to be checked over the space of all possible variations (e.g., inputs and system configurations). Thus, a metamodel may be useful to model system 100 by increasing the coverage of system 100. A metamodel may be a multivariate function and/or expression that assign a unique value to each response given a set of values for the factors. Each factor in a metamodel may have a limited range from minimum to maximum, so that the predicted value of the response of the metamodel is realized over a bounded multi-dimensional space. A computing device may, given a dataset comprising a set of data points with values for factors and responses generated from measurement and/or simulation of system 100, estimate the best fitting metamodel for a response by minimizing the errors between the predicted value for the response and the response value. Such errors may be called residuals, and the process of checking the residuals for a given data set may be called validation. The best fitting metamodel may be validated and may be used by evaluating its value for the data point of interest.

To validate a system, such as system 100, that can be separated into components, the computing device may validate each component separately, and the computing device may synthesize the results of validating each component as metamodels. The computing device may determine the equivalent model for the system by applying one or more operations described below to the metamodels of the components of the system. For example, each of power supply unit 102, microcontroller 104, a measurement unit 106, a diagnosis unit 108, a communication unit 110, a supervision and reset unit 112, a driver unit 114, and a power switch and protection unit 116 may be symbolically described as a separate metamodel, and these separate metamodels may be synthesized to produce a metamodel that symbolically describes ECU 101. The metamodel of ECU 101 along with metamodels for actuator 103 and power window 105 may be synthesized to produce metamodel 118 that symbolically describes system 100.

Metamodel 118 may symbolically describe system 100 with respect to its performance and/or characteristics, and represents deterministic approximations of the response of system 100 with respect to variations in the factors over a space of interest. A computing device may create metamodel 118 and use metamodel 118 for simulating system 100. For example, a user of the computing device may use a software application such as MATLAB to create and generate metamodel 118. To generate metamodel 118, system 100 can be tested and/or simulated under a limited variety of conditions to generate a set of data points of system 100's performance over that variety of conditions. For example, the performance of system 100 may be tested under a limited range of conditions, including limited ranges of tolerances of electrical components, calibration parameters of a regulation loop, fluctuations of transmission delay on the bus, the operating temperature, variations in supply voltage, variations in chip fabrication, and the like to generate a data set of the range in control signals outputted by system 100. A mathematical expression, such as a polynomial equation, may be fitted to the data set, such as by estimating coefficients of the polynomial equation, to generate an equation that predicts the values of one or more response 122 given any set of factors 120A-120N, so that the expression may be able to predict the output of system 100 given any set of ranges of conditions, and the expression may be used as metamodel 118 that predicts the values of one or more responses 122 given factors 120A-120N. Thus, a metamodel, such as metamodel 118 may enable interpolation of data points to predict response values between the simulated and/or measured data points as well as optimization of responses by predicting for which factors the best fitting metamodel will be optimal, and the like.

The effect of factors on responses can be illustrated graphically. FIGS. 1B and 1C are block diagrams illustrating responses versus factors of a metamodel. As shown in FIG. 1B, response 156 of metamodel 152 may be plotted against factors 154A-154E. For example metamodel 152 may be built from simulations of a voltage regulator that may require a precise delay in the reset pulse to a microcontroller once the voltage regulator's output is stable. Response 156 may be the time of the delay in the reset pulse. Factor 154A may be variations in an input voltage, factor 154B may be variations in ambient temperature, factor 154C may be variations in an output resistance, and factors 154D and 154E may be variations in the filters at the voltage regulator's reset output capacitor and resistor, respectively.

Factors having variations that affect response 156 of metamodel 152 as the factors vary may be considered significant factors. The significant factors for metamodel 152 can be visually identified as factor 154B and factor 154D because response 156 changes when factors 154B and 154D change. Meanwhile, the insignificant factors for metamodel 152 can be visually identified as factors 154A, 154C, and 154E because response 156 does not change when factors 154A, 154C, and 154E change. The significant factors for metamodel 152 may also be determined via, for example, sensitivity analysis.

A computing device may operate on metamodel 152 to remove extraneous factors, thereby simplifying the processing and use of metamodel 152 in simulation and increasing the efficiency of the simulation or measurement-based verification via metamodels. For example, because factors 154A, 154C, and 154E do not affect response 156 of metamodel 152, a computing device can apply a reduce operation to metamodel 152 to remove insignificant factors 154A, 154C, and 154E, thereby simplifying metamodel 152 without significantly mathematically affecting the operation of metamodel 152. As shown in FIG. 1C, metamodel 152 may be reduced to include only the significant factors 154B and 154D. Applying the reduce operation to metamodel 152 may include refitting (i.e., reestimating coefficients of metamodel 152) only the significant factors 154B and 154D and considering the insignificant factors 154A, 154C, and 154E as sources of noise. Multiple data points, such as points where the significant factors have the same value, may be averaged when performing the fitting and the residuals, such as errors between data points and predictions from the metamodel, may be analyzed and validated for all points. In this way, metamodel 152 may be simplified to include fewer factors.

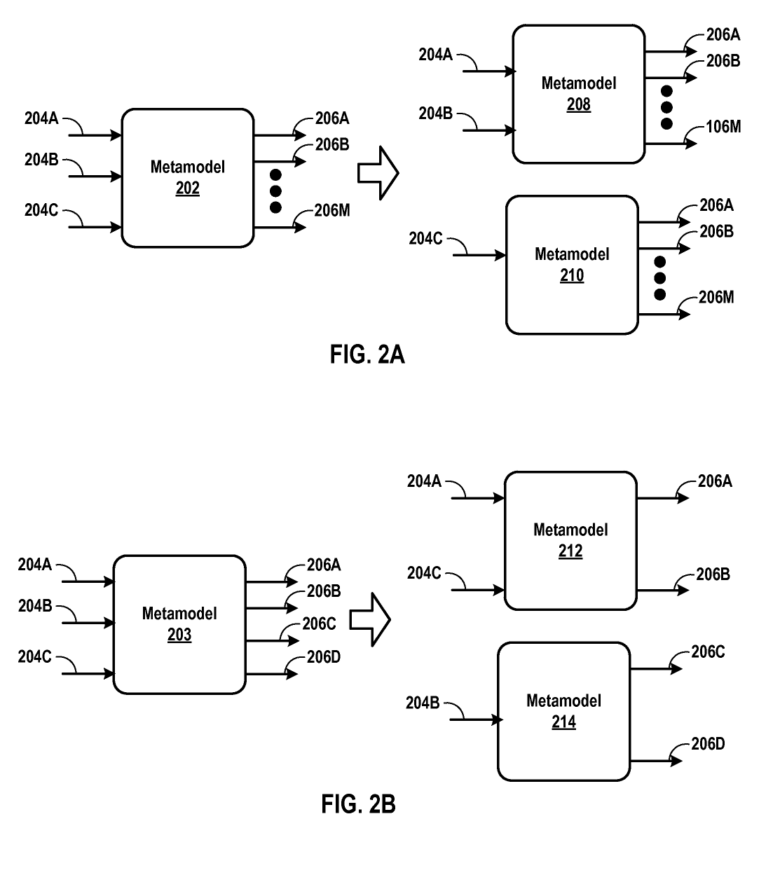

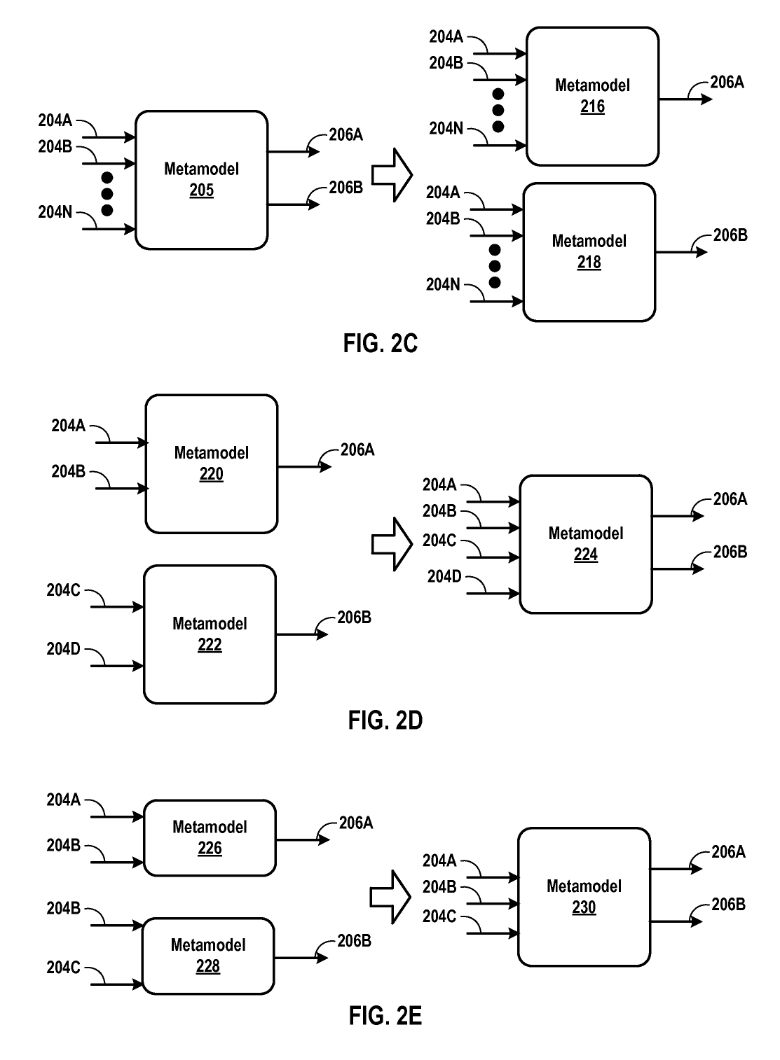

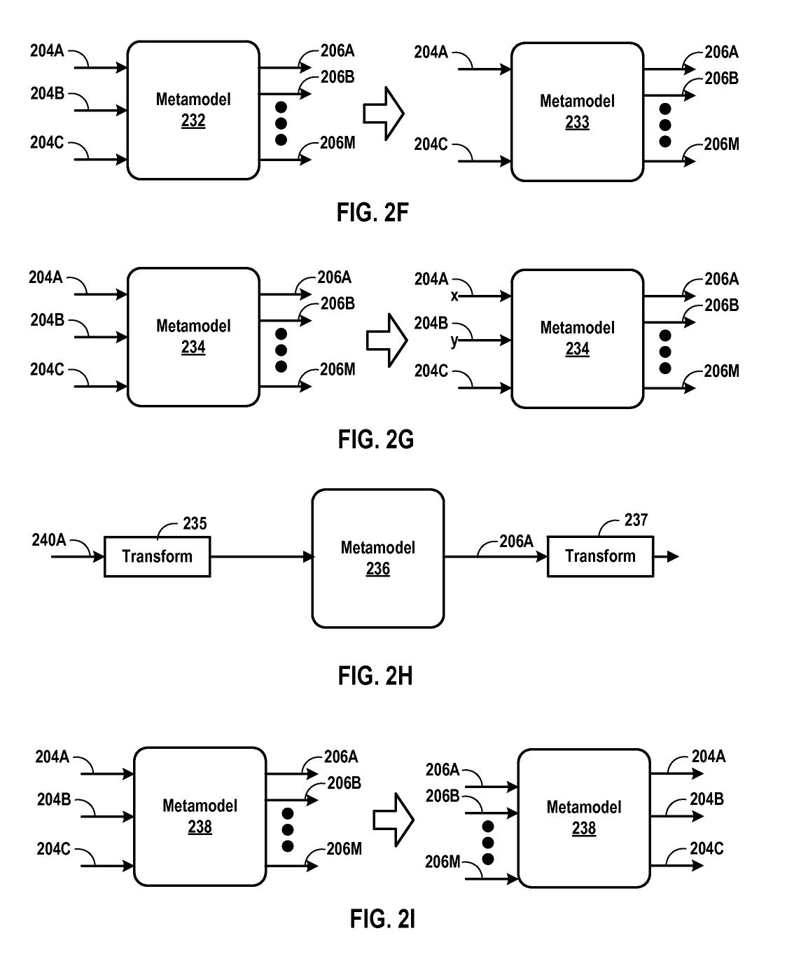

Similarly, a computing device may perform this as well as other operations on a metamodel. For example, as discussed above with respect to FIGS. 1B and 1C, the effect of a factor on the response may be based on individual effects of the factor and/or interaction effects (i.e., effects that depend on the levels to which factors are set) of the factor that depends on the level of other factors. In some examples, a computing device may operate on a metamodel to split factors of metamodels that do not interact significantly in their impact on the output. FIG. 2A is a block diagram illustrating an example split operation performed on an example metamodel. As shown in FIG. 2A, metamodel 202 may include factors 204A, 204B, and 204C, and responses 206A-206M. If factors 204A and 204B do not interact significantly with factor 204C with respect to their impact on responses 206A-206M associated with metamodel 202, a computing device may split the factors 204A and 204B from factor 204C to split metamodel 202 into metamodel 208 that includes factors 204A and 204B and metamodel 210 that includes factor 204C.

Splitting metamodel 203 into metamodels 212 and 214 may include generating metamodel 212 that behaves similarly to metamodel 203 to output similar responses 206A and 206B in response to factors 204A and 204C, so that given variations in factors 204A and 204C metamodel 212 will output the same range of values for responses 206A and 206B as metamodel 203 will output for responses 206A and 206B. Similarly, splitting metamodel 202 into metamodels 212 and 214 may also include generating metamodel 214 that behaves similarly to metamodel 203 to output similar responses 206C and 206D in response to factor 204B, so that given variations in factor 204B metamodel 214 will output the same range of values for responses 206C and 206D as metamodel 203 will output for responses 206C and 206D.

A computing device may generate metamodels 212 and 214 via a similar process as described above to generate metamodel 118. To generate metamodels 212 and 214, the computing device may use metamodel 203 to generate, via prediction and/or evaluation of a limited number of data points, a data set comprising a first data set having input factors 204A and 204B and responses 206A and 206B, and further comprising a second data set having input factor 204B and responses 206C and 206D. The generated datasets may be fitted to one or more mathematical expressions, such as polynomial expressions, so that response 206A may be the function of a polynomial expression with factors 204A and 204B as the variables, and response 206B may be the function of a polynomial expression with factors 204A and 204B as the variables.

In some examples, if different responses associated with a metamodel are influenced by different subsets of factors of the metamodel, then a computing device may split the metamodel so that each resulting metamodel includes a subset of responses and a subset of factors that influence the subset of responses. FIG. 2B is a block diagram illustrating another example split operation performed on an example metamodel. As shown in FIG. 2B, metamodel 203 may include factors 204A, 204B, and 204C, and may further include responses 206A, 206B, 206C, and 206D. If responses 206A and 206B are only influenced by factors 204A and 204C, and if responses 206C and 206D are only influenced by factor 204B, the computing device can split metamodel 203 into metamodel 212 and metamodel 214. Metamodel 212 may include factors 204A and 204C and responses 206A and 206B, while metamodel 114 may include factor 204B and responses 206C and 206D.

In some examples, a computing device may split responses of a metamodel, which may be useful when some of the responses of a metamodel are not correlated to each other. FIG. 2C is a block diagram illustrating another example split operation performed on an example metamodel. As shown in FIG. 2C, metamodel 205 may include factors 204A-104N and responses 206A and 206B. If responses 206A and 206B are not correlated with each other, a computing device may split response 206A from response 206B by splitting metamodel 202 to create metamodel 216 that includes factors 204A-204N and response 206A, and metamodel 218 that includes factors 204A-204N and response 206B.

In some examples, two or more metamodels may be merged into a single metamodel that is associated with all of the factors and all of the responses of the metamodels that are to be merged together. FIG. 2D is a block diagram illustrating an example merge operation performed on an example metamodel. As shown in FIG. 2D, metamodel 220 may include factors 204A and 204B and response 206A, and metamodel 222 may include factors 204C and 204D and response 206B. A computing device may merge metamodel 220 and metamodel 222 to result in metamodel 224 that includes factors 204A, 204B, 204C, and 204D, and responses 206A and 206B.

In some examples, if two or more metamodels to be merged have common factors, then the resulting metamodel from merging the two or more metamodels may also merge the common factors. FIG. 2E is a block diagram illustrating another an example merge operation performed on an example metamodel. As shown in FIG. 2E, metamodel 226 may include factors 204A and 204B, and response 206A. Metamodel 228 may include factors 204B and 204C, and response 206B. As can be seen, metamodel 226 and metamodel 228 have a common factor 204B. A computing device may merge metamodel 226 and metamodel 228 to result in metamodel 230 that merges common factor 204B, so that metamodel 230 is associated with factors 204A, 204B, and 204C, and with responses 206A and 206B.

In some examples, a computing device may analyze the factors of a metamodel to determine insignificant factors that do not significantly affect the metamodel's responses. FIG. 2F is a block diagram illustrating a reduce operation performed on an example metamodel. As shown in FIG. 2F, metamodel 232 may include factors 204A, 204B, and 204C, and responses 206A-206M. If a computing device determines that factor 204B is an insignificant factor, the computing device may remove factor 204B from metamodel 232, resulting in metamodel 233 that includes factors 204A and 204C, and responses 206A-206M.

In some examples, computing device may set one or more factors of a metamodel as a fixed value. FIG. 2G is a block diagram illustrating another reduce operation performed on an example metamodel. As shown in FIG. 2G, metamodel 234 may include factors 204A, 204B, and 204C, and responses 206A-206M. A computing device may set factor 204A as fixed value x and may set factor 204B as fixed value y such that only factor 204C may vary. Thus, responses 206A-206M for metamodel 234 may be responses resulting from fixed factors 204A and 204B and varying factor 204C.

In some examples, mathematical operations may be applied to factors and/or responses of a metamodel. FIG. 2H is a block diagram illustrating a transform operation performed on example factors and/or example responses of an example metamodel. As shown in FIG. 2H, mathematical operation 235 may be applied to factor 204A of metamodel 236. Mathematical operation 237 may also be applied to response 206A of metamodel 236. Mathematical operations 235 and 237 may include any suitable mathematical operation, such as logarithmic operations, exponential operations, and the like.

In some examples, a computing device may perform an inverse operation on a metamodel. FIG. 21 is a block diagram illustrating an inverse operation performed on example factors and/or example responses of an example metamodel. As shown in FIG. 21, metamodel 238 may reverse inputs with outputs so that factors 204A-204C may become responses and responses 206A-206M may become inputs. Such an inverse operation may be performed if each response is represented by a metamodel which is a mathematically bijective function. For example, if the dependency of a system delay on a component delay is linear, then it can be expressed both as system delay=metamodel(component delay)=a*component_delay+b, as well as component delay=metamodel̂(−1)(system delay)=−b/a+(1/a)*(system delay).

In some examples, a computing device may perform a derive operation on a metamodel, so that the computing device may remove a subset of factors and may replace the responses with one of the statistical characteristics with respect to the removed factors. In this way, the metamodel of a statistical characteristic of an initial metamodel may be derived FIG. 2J is a block diagram illustrating a derive operation performed on an example metamodel. As shown in FIG. 2J, if metamodel 241 includes factors 241A and 241B and response 242, and if average of response 242 over the complete range of factor 241B depends only on factor 241A, a computing device can compute metamodel 243 by fitting the set of average values for response 242 obtained by evaluating metamodel 241 in a sufficient number of points for factor 241A and averaged over all possible values of factor 241B. Similarly, the computing device may derive other statistical characteristics, such as dispersion, maximum and minimum, specific quantiles, and the like for the response,

In some examples, a computing device may perform a cascading operation on a plurality of metamodels, so that responses of a metamodel may become factors of another metamodel. Furthermore, mathematical operators may operate on the factors and/or responses of the metamodels. Cascading a plurality of metamodels may be useful in verifying a system including a plurality of interconnected components that are each modeled by a metamodel.

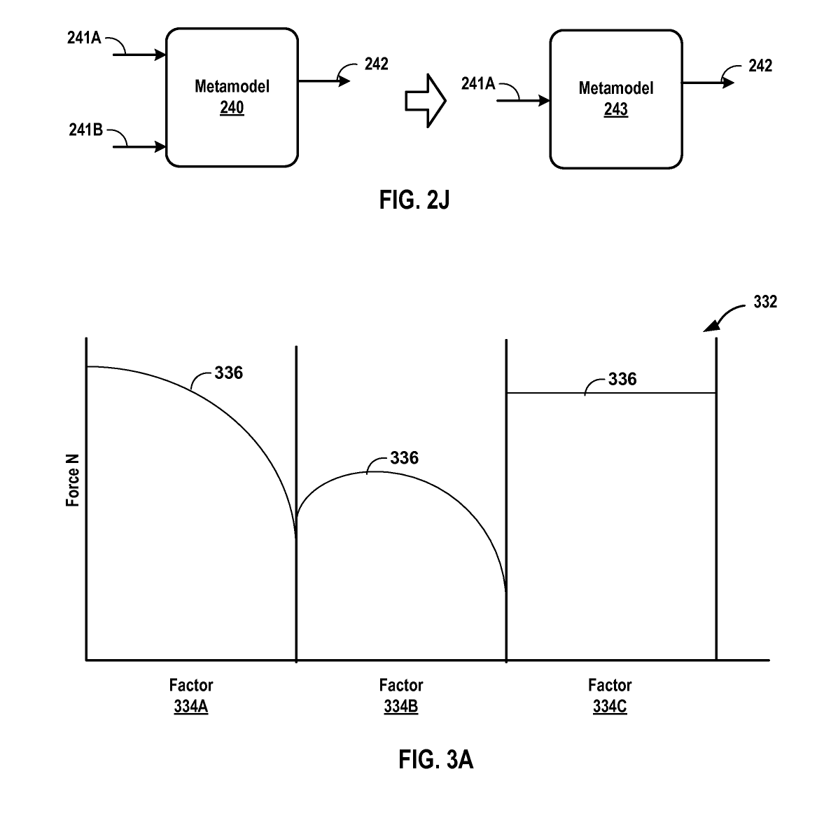

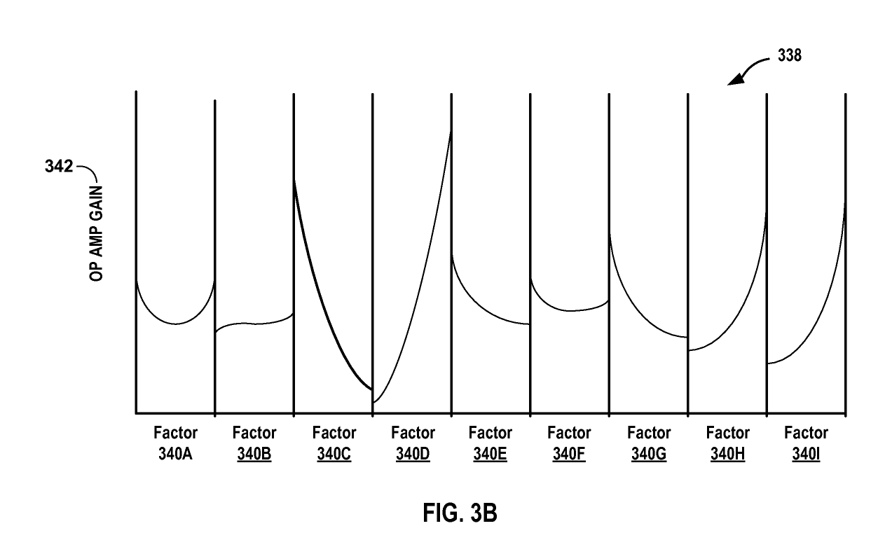

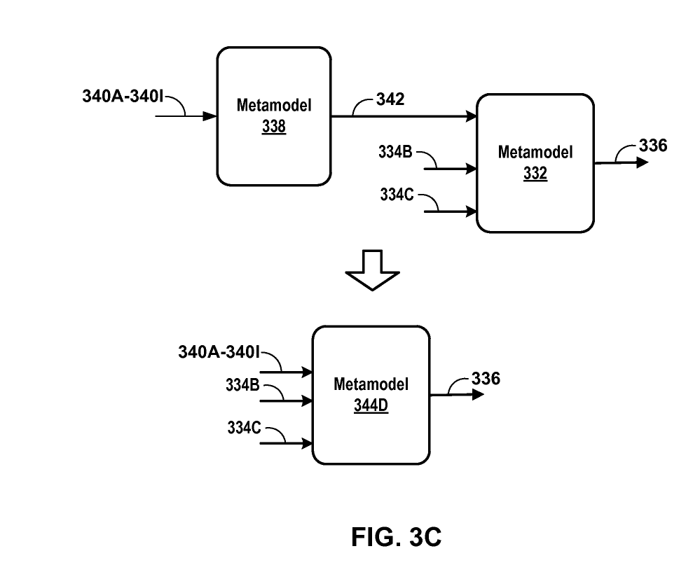

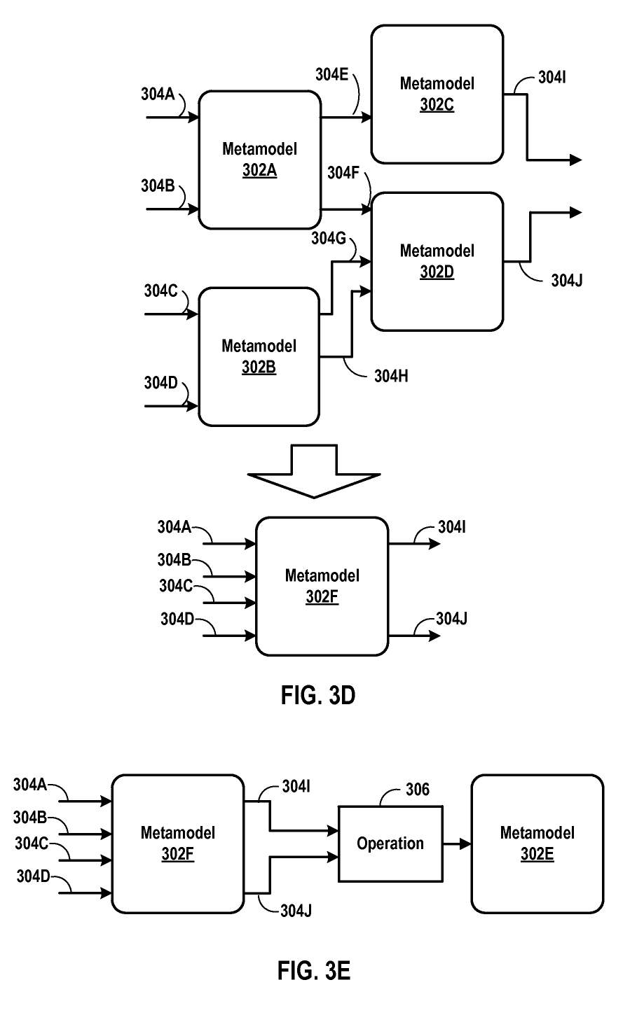

As discussed above, system 100 shown in FIG. 1 may be impacted by process variations. System-level simulations of a model of system 100 can be performed to determine the impact of the parameters of system 100 on the force present in an obstacle for power window 105. The results of the simulations may be used to build a metamodel, which is then used to identify the most important factors of the metamodel in the force present in the obstacle for power window 105. FIG. 3A is a block diagram illustrating how the metamodel may be used to determine the most important factors for system 100.

As shown in FIG. 3A, metamodel 332 models the force 336 (in Newton) applied to an obstacle by power window 106 controlled by ECU 101 against simulations of variations in factors 334A-334C. Factor 334A may be the gain of an op amp of measurement unit 106, factor 334B may be the supply voltage of ECU 101, and factor 334C may be the low-side switches (LSS) delay of power switch & protection unit 116. In the example of FIG. 3A, variations in factor 334B may have a quadratic effect on force 336 because larger supply voltage may determine a faster ECU 101 and therefore a bigger force 336 on the obstacle for power window 105. However, from a given point ECU 101 may become so fast that the electronics of ECU 101 will also react faster to the condition and switch off. Variations in factor 334C may have very little impact on force 336. Variations in factor 334A may have a big negative effect on force 336 because a higher gain of the op amp may allow ECU 101 to react more quickly to switch off the motor driving the power window. As can be seen from the results illustrated in FIG. 3A, the metamodel may help quantify the effects of factors 334A-C and enable predictions to be made regarding how factors of system 100, mechanics, and environment impacts the magnitude of force 336 when there is an obstacle.

A metamodel of the op amp of measurement unit 106 of ECU 101 may also be used to determine the most important factors of the op amp. FIG. 3B is a block diagram illustrating responses versus factors of a metamodel for an op amp. As shown in FIG. 3B, metamodel 338 models the op amp gain 342 of the op amp against measurements of variations in factors 340A-340I. Factors 340A and 340B are variations in the X and Y die positioning of the op amp component on a semiconductor wafer of ECU 101. Factors 340C-340I are technology-specific process variations.

Metamodel 338 and metamodel 332 can be cascaded so that op amp gain 342 modeled by metamodel 338 can be used as the input into metamodel 332 as factor 334A to create a global metamodel that describes how process variations as well as other factors may impact the force of power window 105 against an obstacle. As can be seen, because metamodel 332 is created based on simulation while metamodel 338 is created based on measurements, the global metamodel may have the benefit of information coming from different test environments. Because metamodel 332 is simulated at a system level while metamodel 338 is measured at a wafer level, the global metamodel may also have the benefit of information coming from different levels of abstraction.

FIG. 3C is a block diagram illustrating cascading metamodel 338 and metamodel 332. As shown in FIG. 3C, global metamodel 344 may be created as the result of cascading metamodel 338 and metamodel 332. Global metamodel 344 may include factors 340A-340I from metamodel 338 as well as factors 334B and 334C from metamodel 332, and may include response 336 from metamodel 332 that is the force from power window 105 exerted onto the obstacle. Global metamodel 344 may be used to determine which constraints to put on system 100 so that safety requirements of ECU 101 and power window 105 it controls are met.

As can be seen, the cascade operation can be applied when different metamodels are extracted from different environments, such as simulations and/or measurements of different domains or on different abstraction levels. If the response of a lower abstraction simulation or measurement can serve as an input factor for a higher level of abstraction, then the resulting metamodel may be a mathematical expression of how high-level output responses may vary depending on low-level input factors.

FIG. 3D is a block diagram illustrating replacing an example cluster of metamodels with a mathematically equivalent metamodel. As shown in FIG. 3D, metamodels 302A-302D may be clustered and replaced with mathematically equivalent metamodel 302F. Metamodel 302F may be mathematically equivalent to metamodels 302A-302D because given the same variations in the factors, metamodel 302F may produce the same output in its responses as the set of metamodels 302A-302D. For example, because the leftmost factors for the cluster of metamodels 302A-302D are factors 304A-304D, 302F may include factors 304A-304D. Similarly, because the rightmost responses for the cluster of metamodels 302A-302D are responses 304I and 304J, metamodel 302F may include responses 304I and 304J. The leftmost factors may be referred to as single independent variables and the rightmost factors can be referred to as dependent variables that are not factors to any metamodel.

A computing device may cluster metamodels 302A-302D to generate the mathematically equivalent metamodel 302F via a similar process as used to generate metamodel 118 shown in FIG. 1. The computing device may, given variations in factors 304A-304D, create a data set of values output in responses 304I and 304J. The generated dataset may be fitted to one or more mathematical equations, such as polynomial equations, so that responses 304I and 304J may both be the function of a polynomial equation with factors 304A-304D as the variables, and these functions may be included in metamodel 302F. The computing device may generate metamodel 302F by computing a sufficient dataset for factors 304A-304D and responses 304I-304J and fitting the results of the computation into metamodel 302F.

FIG. 3E is a block diagram illustrating performing mathematical operations on a metamodel. As shown in FIG. 3E, mathematical operation 306 may be performed on responses 304I and 304J of metamodel 302F and the result of mathematical operation 306 may be a factor in metamodel 302E. For example, mathematical operation 306 may be an algebraic operation, such as addition, subtraction, multiplication, division, and the like. Mathematical operation 306 may also be any other suitable mathematical operation, including but not limited to logarithmic operations, exponential operations, sine operations, cosine operations, tangent operations, and the like.

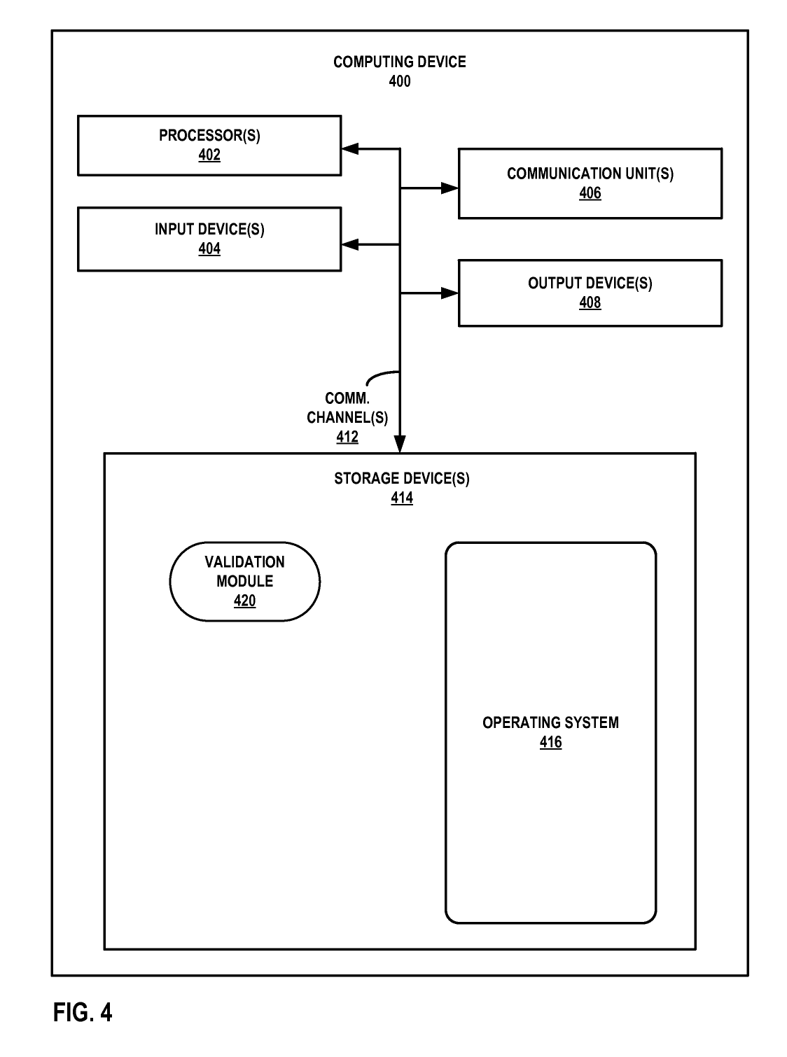

FIG. 4 is a block diagram illustrating an example computing device. Computing device 400 may be one example of a computing device that performs operations on metamodels as described above with respect to FIGS. 1A-1C, 2A-2C, and 3A-3E. In other examples, computing device 400 can include fewer, additional, or different components compared to those illustrated in FIG. 4. As shown in the example of FIG. 4, computing device 400 may include one or more processors 402, one or more input devices 404, one or more communication units 406, one or more output devices 408, and one or more storage devices 414. In this example, storage devices 414 of computing device 400 may include operating system 416, and validation module 420. Communication channels 412 may interconnect each of the components 402, 404, 406, 408, and 414 for inter-component communications (physically, communicatively, and/or operatively). In some examples, communication channels 412 may include a system bus, a network connection, an inter-process communication data structure, or any other method for communicating data.

One or more input devices 404 of computing device 400 may receive input. Examples of input are tactile, audio, and video input. Input devices 404 of computing device 400, in one example, include a presence-sensitive display, touch-sensitive screen, mouse, keyboard, voice responsive system, video camera, microphone or any other type of device for detecting input from a human or machine.

One or more output devices 408 of computing device 400 may generate output. Examples of output are tactile, audio, and video output. Output devices 408 of computing device 400, in one example, include a presence-sensitive display, sound card, video graphics adapter card, speaker, cathode ray tube (CRT) monitor, liquid crystal display (LCD), or any other type of device for generating output to a human or machine.

One or more communication units 406 of computing device 400 may communicate with wired or wireless external devices via one or more networks by transmitting and/or receiving network signals on the one or more networks. For example, computing device 400 may use communication units 406 to transmit and/or receive radio signals on a radio network such as a cellular radio network. Likewise, communication units 406 may transmit and/or receive satellite signals on a satellite network such as a GPS network. Examples of communication units 406 include a network interface card (e.g. such as an Ethernet card), an optical transceiver, a radio frequency transceiver, a GPS receiver, or any other type of device that can send and/or receive information. Other examples of communication units 406 may include Bluetooth®, GPS, 3G, 4G, and Wi-Fi® radios found in mobile devices as well as Universal Serial Bus (USB) controllers.

One or more storage devices 414 within computing device 400 may store information required for use during operation of computing device 400. Storage devices 414, in some examples, have the primary purpose of being short term and not long-term computer-readable storage mediums. Storage devices 414 on computing device 400 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art. Storage devices 414 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 414 may store program instructions and/or data associated with validation module 420.

One or more processors 402 may implement functionality and/or execute instructions within computing device 400. For example, processors 402 on computing device 400 may read and execute instructions stored by storage devices 414 that execute the functionality of validation module 420. These instructions executed by processors 402 may cause computing device 400 to store information within storage devices 414 during program execution. Processors 402 may execute validation module 420 to perform various actions.

Storage devices 414 may include validation module 420. Validation module 420, in some examples, may be a computer program such as MATLAB that may be used by a user of computing device 400 to create and perform operations on metamodels to simulate systems represented by the metamodels. Validation module 420 may execute on processors 402 to validate a system, including creating one or more metamodels of the system and validating the created metamodels. Creating the one or more metamodels may include simulating a system over a limited set of variations of operating condition to produce a data set of system outputs and fitting the data set of system outputs to polynomials to generate mathematical equations where the outputs of a metamodel are the functions of the operating conditions. The metamodels may include the generated equations, so that the metamodels may act as mathematical approximations of the system to be validated.

Validation module 420 may further execute on processor 402 to perform operations on the one or more metamodels created by validation module 420. For example, validation module 420 may be able to perform split operations, merge operations, reduce operations, transform operations, inverse operations, and derive operations similar to the operations described above with respect to FIGS. 2A-2J. Validation module 420 may also be able to perform cascading operations similar to the operations described above with respect to FIGS. 3A-3E.

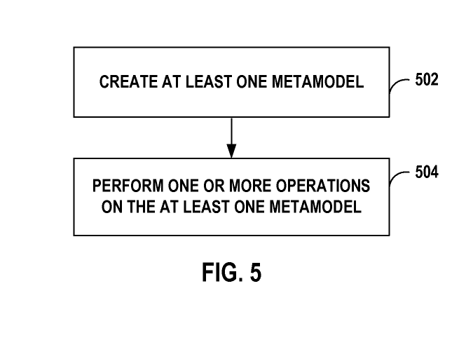

FIG. 5 is a flowchart illustrating a process for performing operations on one or more metamodels. As shown in FIG. 5, at least one processor of a computing device, such as computing device 400 shown in FIG. 4, may create at least one metamodel (502). The at least one processor of the computing device may further perform one or more of: a split operation on the at least one metamodel, a merge operation on the at least one metamodel, a reduce operation on the at least one metamodel, a mathematical transform of the at least one metamodel, an inverse operation on the at least one metamodel, a derive operation on the at least one metamodel, cascading of the at least one metamodel, and an algebraic operation on the at least one metamodel (504).

In some examples, the at least one processor performing one or more of: the split operation on the at least one metamodel may further include determining, by the at least one processor, a first factor of a metamodel in the at least one metamodel that does not interact with a second factor of the metamodel, and separating, by the at least one processor, the first factor of the metamodel from the second factor of the metamodel, including creating a first metamodel including the first factor and a second metamodel including the second factor.

In some examples, the at least one processor performing one or more of: the split operation on the at least one metamodel may further include separating, by the at least one processor, at least a first response of a metamodel in the at least one metamodel from at least a second response of the metamodel, including creating a first metamodel including the at least the first response and creating a second metamodel including at least the second response.

In some examples, the at least one processor performing one or more of: the merge operation on the at least one metamodel may further include merging, by the at least one processor, a first metamodel of the at least one metamodel with a second metamodel of the at least one metamodel to create a third metamodel.

In some examples, the at least one processor performing one or more of: the reduce operation on the at least one metamodel may further include removing, by the at least one processor, one or more insignificant factors from a metamodel in the at least one metamodel.

In some examples, the at least one processor performing one or more of: the reduce operation on the at least one metamodel may further include setting, by the at least one processor, a subset of factors of a metamodel in the at least one metamodel at fixed levels.

In some examples, the at least one processor performing one or more of: the transform operation on the at least one metamodel may further include applying, by the at least one processor, a mathematical transform to at least one of a factor and a response associated with a metamodel in the at least one metamodel.

In some examples, the at least one processor performing one or more of: the inverse operation on the at least one metamodel may further include transforming, by the at least one processor, one or more factors associated with a metamodel in the at least one metamodel in one or more responses associated with the metamodel.

In some examples, the at least one processor performing one or more of: the inverse operation on the at least one metamodel may further include transforming, by the at least one processor, one or more responses associated with a metamodel in the at least one metamodel in one or more factors associated with the metamodel.

In some examples, the at least one processor performing one or more of: the derive operation on the at least one metamodel may further include removing, by the at least one processor, a subset of factors of a metamodel in the at least one metamodel, and replacing, by the at least one processor, responses in the metamodel with one or more statistical characteristics with respect to the subset of factors.

In some examples, the at least one processor performing at least one of: the cascading of the at least one metamodel may further include cascading, by the at least one processor, a first metamodel in the at least one metamodel with a second metamodel in the at least one metamodel so that a response in the first metamodel is a factor in the second metamodel. In some examples, the at least one processor may further create a third metamodel as a parent of the cascaded first metamodel and second metamodel such that the third metamodel is mathematically equivalent to the cascaded first metamodel and second metamodel. In some examples, the at least one processor may further generate the first metamodel based on at least one measurement and generate the second metamodel based on at least one simulation.

In some examples, creating the metamodel comprises creating the metamodel to simulate a response of a physical system in response to variations of a factor of the physical system. In some examples, the at least one factor comprises die positioning on a semiconductor wafer.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Various aspects of the disclosure have been described. Many aspects of this disclosure have been described in the context of a specific type of system, e.g., an automotive electronic control unit (ECU). However, similar techniques may be extended to a wide range of other systems that can be symbolically described with respect to its performance and characteristics by using metamodels to improve the systems' validation coverage against application fitness and verification of its requirements. These and other aspects are within the scope of the following claims.

1. A method for validating a system, comprising:
creating, by at least one processor of a computing device, at least one metamodel; and
performing, by the at least one processor on the at least one metamodel, one or more of: a split operation, a merge operation, a reduce operation, a mathematical transform, an inverse operation, a derive operation, a cascading operation, and an algebraic operation.

2. The method of claim 1, wherein performing, on the at least one metamodel, one or more of: the split operation further comprises:
determining, by the at least one processor, a first factor of a metamodel in the at least one metamodel that does not interact with a second factor of the metamodel; and
separating, by the at least one processor, the first factor of the metamodel from the second factor of the metamodel, including creating a first metamodel including the first factor and a second metamodel including the second factor.

3. The method of claim 1, wherein performing, on the at least one metamodel, one or more of: the split operation further comprises:
separating, by the at least one processor, at least a first response of a metamodel in the at least one metamodel from at least a second response of the metamodel, including creating a first metamodel including the at least the first response and creating a second metamodel including at least the second response.

4. The method of claim 1, wherein performing, on the at least one metamodel, one or more of: the merge operation further comprises:
merging, by the at least one processor, a first metamodel of the at least one metamodel with a second metamodel of the at least one metamodel to create a third metamodel, including merging a common factor associated with the first metamodel and the second metamodel into single factor associated with the third metamodel.

5. The method of claim 1, wherein performing, on the at least one metamodel, one or more of: the reduce operation further comprises:
removing, by the at least one processor, one or more insignificant factors from a metamodel in the at least one metamodel.

6. The method of claim 1, wherein performing, on the at least one metamodel, one or more of: the reduce operation further comprises:
setting, by the at least one processor, a subset of factors of a metamodel in the at least one metamodel at fixed levels.

7. The method of claim 1, wherein performing, on the at least one metamodel, one or more of: the transform operation further comprises:
applying, by the at least one processor, a mathematical transform to at least one of a factor and a response associated with a metamodel in the at least one metamodel.

8. The method of claim 1, wherein performing, on the at least one metamodel, one or more of: the inverse operation further comprises:
transforming, by the at least one processor, one or more factors associated with a metamodel in the at least one metamodel in one or more responses associated with the metamodel.

9. The method of claim 1, wherein performing, on the at least one metamodel, one or more of: the derive operation further comprises:
removing, by the at least one processor, a subset of factors of a metamodel in the at least one metamodel; and
replacing, by the at least one processor, responses in the metamodel with one or more statistical characteristics with respect to the subset of factors.

10. The method of claim 1, wherein performing, on the at least one metamodel, at least one of: the cascading operation further comprises:
cascading, by the at least one processor, a first metamodel with a second metamodel so that a response in the first metamodel is a factor in the second metamodel.

11. The method of claim 1, wherein:
creating the metamodel comprises creating the metamodel to approximate at least one response of a physical system in response to variations of at least one factor of the physical system;
the at least one factor comprises die positioning on a semiconductor wafer; and
the at least one response comprises measurement results.

12. A computer-readable storage medium comprising instructions that, when executed by at least one processor, causes the at least one processor to perform operations comprising:
creating at least one metamodel; and
performing, on the at least one metamodel, one or more of: a split operation, a merge operation, a reduce operation, a mathematical transform, an inverse operation, a derive operation, a cascading operation, and an algebraic operation.

13. The computer-readable storage medium of claim 12, wherein performing, on the at least one metamodel, one or more of: the split operation further comprises:
determining a first factor of a metamodel in the at least one metamodel that does not interact with a second factor of the metamodel; and
separating the first factor of the metamodel from the second factor of the metamodel, including creating a first metamodel including the first factor and a second metamodel including the second factor.

14. The computer-readable storage medium of claim 12, wherein performing, on the at least one metamodel, one or more of: the split operation further comprises:
separating at least a first response of a metamodel in the at least one metamodel from at least a second response of the metamodel, including creating a first metamodel including the at least the first response and creating a second metamodel including at least the second response.

15. The computer-readable storage medium of claim 12, wherein performing, on the at least one metamodel, one or more of: the merge operation further comprises:
merging a first metamodel of the at least one metamodel with a second metamodel of the at least one metamodel to create a third metamodel, including merging a common factor associated with the first metamodel and the second metamodel into single factor associated with the third metamodel.

16. The computer-readable storage medium of claim 12, wherein performing, on the at least one metamodel, one or more of: the reduce operation further comprises:
removing one or more insignificant factors from a metamodel in the at least one metamodel.

17. The computer-readable storage medium of claim 12, wherein performing, on the at least one metamodel, one or more of: the reduce operation further comprises:
setting a subset of factors of a metamodel in the at least one metamodel at fixed levels.

18. The computer-readable storage medium of claim 12, wherein performing, on the at least one metamodel, one or more of: the transform operation further comprises:
applying a mathematical transform to at least one of a factor and a response associated with a metamodel in the at least one metamodel.

19. A computing system comprising:
a memory;
at least one processor; and
at least one module executing on the at least one processor and configured to:
create at least one metamodel; and
perform, on the at least one metamodel, one or more of: a split operation, a merge operation, a reduce operation, a mathematical transform, an inverse operation, a derive operation, a cascading operation, and an algebraic operation.

20. The computing system of claim 19,
wherein the at least one module, when performing, on the at least one metamodel, one or more of: the reduce operation, sets a subset of factors of a metamodel in the at least one metamodel at fixed levels.

21. The computing system of claim 19, wherein the at least one module, when performing, on the at least one metamodel, one or more of: the transform operation, applies a mathematical transform to at least one of a factor and a response associated with a metamodel in the at least one metamodel.

22. The computing system of claim 19, wherein the at least one module, when performing, on the at least one metamodel, one or more of: the inverse operation, transforms one or more factors associated with a metamodel in the at least one metamodel in one or more responses associated with the metamodel.

23. The computing system of claim 19, wherein the at least one module, when performing, on the at least one metamodel, one or more of: the derive operation, removes a subset of factors of a metamodel in the at least one metamodel, and replaces responses in the metamodel with one or more statistical characteristics with respect to the subset of factors.

24. The computing system of claim 19,
wherein the at least one module, when performing, on the at least one metamodel, at least one of: the cascading operation, cascades a first metamodel with a second metamodel so that a response in the first metamodel is a factor in the second metamodel.

25. The computing system of claim 19, wherein:
create the metamodel comprises create the metamodel to approximate at least one response of a physical system in response to variations of at least one factor of the physical system;
the at least one factor comprises die positioning on a semiconductor wafer; and
the at least one response comprises measurement results.
